(19) United States
(12) Patent Application Publication
(10) Pub. No.: US 2026/0116376 A1
(43) Pub. Date: Apr. 30, 2026

(54) COMPUTING HEIGHT INFORMATION OF A CURB IN AN ENVIRONMENT OF A VEHICLE

(71) Applicant: CONNAUGHT ELECTRONICS Ltd., Tuam, County Galway (IE)

(72) Inventors: Ciaran Gallagher, Tuam (IE); Catherine Enright, Tuam (IE); Nagarajan Balmukundan, Chennai (IN)

(73) Assignee: CONNAUGHT ELECTRONICS Ltd., Tuam, County Galway (IE)

(21) Appl. No.: 19/118,662

(22) PCT Filed: Sep. 27, 2023
(86) PCT No.: PCT/EP2023/076624

§ 371 Date: Apr. 4, 2025

(30) Foreign Application Priority Data
Oct. 6, 2022 (DE) 10 2022 125 766.5

(51) Int. Cl. B60W 30/06; G06T 7/60; G06T 7/73; G06V 10/764; G06V 20/56; G06V 20/58; G06V 20/70

(52) U.S. Cl. CPC B60W 30/06; G06T 7/60; G06T 7/73; G06V 10/764; G06V 20/586; G06V 20/588; G06V 20/70; B60W 2420/403; B60W 2552/50; G06T 2207/30244; G06T 2207/30264

(57) ABSTRACT

For computing height information of a curb, line segments approximating the curb in a ground plane are determined, a perpendicular bisector of a first line segment is computed, and a second segment are determined, which intersects the perpendicular bisector. A first plane including the first segment and a second plane including the second segment are determined. A midpoint of the first segment is projected to the second plane and an intersection point of the second segment is projected to the first plane. Depending on respective resulting heights, the first and the second segment are classified as upper and lower, respectively. An upper point of the upper segment is projected to a further plane, which is perpendicular to the ground plane and includes the lower segment, and a height of the projected upper point above the ground plane is determined.

The invention is directed to a computer-implemented method for computing height information of a curb in an environment of a vehicle, to a method for semi-automated or fully automated parking of a vehicle to a parking space, which is at least in part confined by a curb to a data processing device, to an electronic vehicle guidance system, to computer programs and to a computer readable storage device.

Automatic or semi-automatic driving functions of a vehicle, in particular automatic or semi-automatic parking functions, use images generated by a camera of the vehicle to perceive the environment and assist a driver of the vehicle and/or guide the vehicle automatically or semi-automatically accordingly taking into account objects in the environment. Curbs are particularly relevant objects in certain applications, including parking functions. Object detection algorithms or semantic segmentation algorithms can be used to identify and localize curbs in images.

Not only the position of the curb may be relevant for said vehicle functions but also its height, for example in order to estimate whether a bumper of the vehicle is in danger of hitting the curb.

Document US 2017/0220878 A1 describes a method for detecting a curbstone in an environment of a vehicle. The method includes recognizing at least one line segment that belongs to the curbstone with the aid of image data that are read in by an interface to a camera device of the vehicle. The line segment is projected onto a ground plane of the environment in order to generate a projected line segment. A subset of a plurality of three-dimensionally triangulated points in the environment of the vehicle is assigned to the line segment as a function of a position of the points relative to a position of the camera device, relative to a starting point of the projected line segment, and relative to an end point of the projected line segment. A flank plane of the curbstone is ascertained with the aid of the assigned points.

Therein, the three-dimensionally triangulated points are obtained by using a structure from motion, SfM, algorithm, which can obtain 3D information from overlapping time-shifted images, taking advantage of parallax. Consequently, the method cannot extract the height of the curbstone from a single image.

It is an objective of the present invention to provide a possibility to compute height information of a curb from an image depicting the curb, without requiring images captured at different time instances.

This objective is achieved by the respective subject matter of the independent claims. Further implementations and preferred embodiments are subject matter of the dependent claims.

The invention is based on the idea to evaluate two different line segments and their relative position with respect to each other instead of a temporal shift of a single line segment.

According to an aspect of the invention, a computer-implemented method for computing height information of a curb in an environment of a vehicle, in particular a motor vehicle, is provided. The computer-implemented method comprises at least the following steps i) to viii). It is noted that the enumeration of steps i) to viii) does not necessarily imply a strict order according to which these steps have to be carried out.

In step i), an image, which depicts the curb, in particular the environment of the vehicle and the curb in the environment, is received from a camera of the vehicle. A set of straight line segments, which approximates a projection of an outline of the curb to a predefined ground plane, in particular a ground plane of the environment, on which the vehicle is located, is determined depending on the image.

In particular, the set of straight line segments is found such that it approximates the projected outline of the curb. To this end, for example respective corners of the curb may be identified in the image, the corners may be projected to the ground plane and the set of straight line segments may be determined based on the projected corners. Alternatively, the image may be transformed into a top view perspective with a viewing direction perpendicular to the ground plane. The resulting top view image then depicts already the projected curb. Consequently, the projected corners of the curb may be directly obtained from the top view image and the set of straight line segments may be determined from them. Each segment of the set of straight line segments may be considered to be defined by two endpoints, which correspond to respective projected corner points of the curb.

In step ii), for a first segment of the set of straight line segments, a perpendicular bisector is computed and a second segment of the set of straight line segments is determined, which intersects the perpendicular bisector of the first segment at an intersection point of the second segment.

The perpendicular bisector corresponds to as a line, which bisects the first segment at 90 degrees. In other words, the perpendicular bisector intersects the first segment at the midpoint at 90 degrees and divides it into two equal parts.

In step iii), a first plane, which is perpendicular to the ground plane and comprises the first segment, in particular the first segment lies completely within the first plane, is determined and a second plane, which is perpendicular to the ground plane and comprises the second segment, in particular the second segment lies completely within the second plane, is determined. In step iv), a midpoint of the first segment is projected to the second plane and the intersection point of the second segment is projected to the first plane by means of respective perspective projections using a predetermined position of the camera as a vanishing point. In step v), one of the first and the second segment is classified as an upper segment and the other one of the first and the second segment is classified as a lower segment depending on respective heights above the ground plane of the projected midpoint and the projected intersection point.

In particular, the lower segment corresponds to a part of the approximated outline of the curb, which lies on the ground plane and the upper segment corresponds to a part of the approximated outline of the curb, which lies above the ground plane.

In step vi), a pair of points is determined, wherein the lower segment comprises a lower point of the pair of points and the upper segment comprises an upper point of the pair of points. Therein, according to step vii), the upper point is projected to a further plane, which is perpendicular to the ground plane and comprises the lower segment, by means of a perspective projection using the position of the camera as a vanishing point. A height of the projected upper point above the ground plane is determined.

The further plane according to step vii) is perpendicular to the ground plane and comprises the lower segment. Thus, the further plane is identical to the first plane, if the first segment is classified as the lower segment, and the further plane is identical to the second plane, if the second segment is classified as the lower segment.

In step viii), height information comprising a position of the lower point in the ground plane and the height of the projected upper point associated to the lower point is stored, for example to a storage device of the vehicle.

Unless stated otherwise, all steps of the computer-implemented method may be performed by at least one computing unit, in particular of the vehicle, which may also be denoted as a data processing device. In particular, the at least one computing unit comprises at least one processing circuit, which is configured or adapted to perform the steps of the computer-implemented method. For this purpose, the at least one computing unit may for example store a computer program comprising instructions which, when executed by the at least one computing unit, cause the at least one computing unit to execute the computer-implemented method.

A computing unit may, in particular, be understood as a data processing device, which comprises processing circuitry. The computing unit can therefore in particular process data to perform computing operations. This may also include operations to perform indexed accesses to a data structure, for example a look-up table, LUT.

In particular, the computing unit may include one or more computers, one or more microcontrollers, and/or one or more integrated circuits, for example, one or more application-specific integrated circuits, ASIC, one or more field-programmable gate arrays, FPGA, and/or one or more systems on a chip, SoC. The computing unit may also include one or more processors, for example one or more microprocessors, one or more central processing units, CPU, one or more graphics processing units, GPU, and/or one or more signal processors, in particular one or more digital signal processors, DSP. The computing unit may also include a physical or a virtual cluster of computers or other of said units.

In various embodiments, the computing unit includes one or more hardware and/or software interfaces and/or one or more memory units.

A memory unit may be implemented as a volatile data memory, for example a dynamic random access memory, DRAM, or a static random access memory, SRAM, or as a non-volatile data memory, for example a read-only memory, ROM, a programmable read-only memory, PROM, an erasable programmable read-only memory, EPROM, an electrically erasable programmable read-only memory, EEPROM, a flash memory or flash EEPROM, a ferroelectric random access memory, FRAM, a magnetoresistive random access memory, MRAM, or a phase-change random access memory, PCRAM.

The camera is, in particular, mounted at the vehicle. The set of straight line segments May be determined directly from the image or the image may be pre-processed, for example transformed according to a predefined perspective, and the set of straight line segments may be determined from the pre-processed image.

The image is a two-dimensional image or, in other words, the camera is a monocular camera and, in particular, not a stereoscopic camera.

Projecting a point to a projection plane by means of a perspective projection using a certain vanishing point may be understood such that a line connecting the point to be projected with the vanishing point is constructed and the intersection point of this line with the projection plane is computed. The intersection point then corresponds to the projected point.

The position of the camera may for example be determined during a calibration, in particular extrinsic calibration, during which the pose of the camera is determined with respect to the vehicle.

The height information comprises the combination of the lower point, in particular its coordinates, and the associated height, which has been determined for the projected upper point. The described steps of the method may be carried out also for further pairs of segments of the set of straight line segments and the height information may therefore contain the respective further lower points and their associated height of the respective further projected upper point. The height information therefore can be considered as a three-dimensional representation of the curb or a part of the curb given by one or more points on the ground plane and associated heights. By exploiting the geometric relations of the first and second segment with respect to each other and with respect to the position of the camera, the three-dimensional representation of the curb or part of the curb may be obtained without making use of images captured at different time instances.

According to several implementations of the computer-implemented method, the upper segment according to step v) is given by the first segment and the lower segment is given by the second segment, if a height of the projected midpoint above the ground plane is greater than a height of the projected intersection point above the ground plane. On the other hand, the upper segment is given by the second segment and the lower segment is given by the first segment, if the height of the projected midpoint above the ground plane is smaller than the height of the projected intersection point above the ground plane.

In this way, the segments can be reliably classified depending as upper and lower segment, respectively.

According to several implementations, according to step vi), a projected position of the camera is determined by projecting the position of the camera to the ground plane. The lower point corresponds to an end point of the lower segment and the upper point corresponds to a point of intersection of the upper segment with a straight line passing through the projected position of the camera and the lower point.

Alternatively, the upper point corresponds to an end point of the upper segment and the lower point corresponds to a point of intersection of the lower segment with a straight line passing through the projected position of the camera and the upper point.

For example, the respective point of intersection may exist only according to one of said two definitions. The corresponding definition for the lower point and upper point may then be used.

According to several implementations, a further pair of points is determined, wherein the lower segment comprises a further lower point of the further pair of points and the upper segment comprises a further upper point of the further pair of points. The further upper point is projected to the plane, which is perpendicular to the ground plane and comprises the lower segment, by means of a perspective projection using the position of the camera as a vanishing point, and a height of the projected further upper point above the ground plane is determined. The height information comprises a position of the further lower point in the ground plane and the height of the projected further upper point associated to the further lower point.

Consequently, a more detailed or more thorough three-dimensional representation of the curb may be obtained.

According to several implementations, the further lower point corresponds to a further end point of the lower segment and the further upper point corresponds to a point of intersection of the further upper segment with a straight line passing through the projected position of the camera and the further lower point.

Alternatively, the further upper point corresponds to a further end point of the upper segment and the further lower point corresponds to a point of intersection of the lower segment with a straight line passing through the projected position of the camera and the further upper point.

For example, the respective point of intersection may exist only according to one of said two definitions. The corresponding definition for the further lower point and further upper point may then be used.

According to several implementations, a semantically segmented image is generated by applying a semantic segmentation algorithm to the image. The set of straight line segments is determined depending on the semantically segmented image.

The semantic segmentation algorithm is, in particular, an algorithm that, when applied to the image assigs one of a predefined set of object classes to each pixel of the camera image. The result is the semantically segmented image. Alternatively, the algorithm may assign the respective object class to each of a cluster of two or more adjacent pixels of the camera image. Semantic segmentation algorithms for processing camera images are well known and may for example be based on a trained artificial neural network.

In particular, one of the object classes may be a curb class. In other words, the semantic segmentation algorithm assigns the curb class to all pixels or clusters of pixels of the image that correspond to the curb. Thus, the outline of the curb may be extracted in a straightforward manner from the semantically segmented image.

According to several implementations, a plurality of corner points of the curb is determined by applying a corner detection algorithm to the semantically segmented image. The plurality of corner points is, in particular all corner points of the plurality of corner points are, projected to the ground plane. The set of straight line segments is determined depending on the projected plurality of corner points.

According to a further aspect of the invention, a method for semi-automated or fully automated parking of a vehicle to a parking space, which is at least in part confined by a curb, is provided. Therein, a computer-implemented method for computing height information of the curb according to the invention is carried out by at least one computing unit of the vehicle. Driver assistance information for guiding the vehicle towards the parking space is output to a driver of the vehicle depending on the height information and/or the vehicle is guided at least in part automatically towards the parking space by generating at least one control signal for affecting a longitudinal and/or lateral control of the vehicle depending on the height information.

At least a part of the driver assistance information may for example be output visually by a display of the vehicle controlled by the at least one computing unit. At least a further part of the driver assistance information may for example be output acoustically by a loudspeaker system of the vehicle controlled by the at least one computing unit.

For guiding the vehicle at least in part automatically, the at least one computing unit may for example generate one or more control signals depending on the height information and transmit the one or more control signals to one or more actuators of the vehicle, which may affect a longitudinal and/or lateral control of the vehicle depending on the one or more control signals.

According to a further aspect of the invention, a data processing device comprising at least one computing unit, which is adapted to carry out a computer-implemented method for computing height information of a curb according to the invention.

According to a further aspect of the invention, an electronic vehicle guidance system for semi-automated or fully automated parking of a vehicle to a parking space, which is at least in part confined by a curb, is provided. Therein, the electronic vehicle guidance system comprises a camera, which is configured to generate an image depicting the curb, and a data processing device according to the invention. The at least one computing unit of the data processing device is configured to generate driver assistance information for guiding the vehicle towards the parking space for a driver of the vehicle depending on the height information and/or at least one control signal for affecting a longitudinal and/or lateral control of the vehicle to guide the vehicle at least in part automatically towards the parking space depending on the height information.

In other words, the electronic vehicle guidance system is configured to carry out a method for semi-automated or fully automated parking of a vehicle according to the invention or carries out such a method.

An electronic vehicle guidance system may be understood as an electronic system, configured to guide a vehicle in a fully automated or a fully autonomous manner and, in particular, without a manual intervention or control by a driver or user of the vehicle being necessary. The vehicle carries out all required functions, such as steering maneuvers, deceleration maneuvers and/or acceleration maneuvers as well as monitoring and recording the road traffic and corresponding reactions automatically. In particular, the electronic vehicle guidance system may implement a fully automatic or fully autonomous driving mode according to level 5 of the SAE J3016 classification. An electronic vehicle guidance system may also be implemented as an advanced driver assistance system, ADAS, assisting a driver for partially automatic or partially autonomous driving. In particular, the electronic vehicle guidance system may implement a partly automatic or partly autonomous driving mode according to levels 1 to 4 of the SAE J3016 classification. Here and in the following, SAE J3016 refers to the respective standard dated June 2018.

Guiding the vehicle at least in part automatically may therefore comprise guiding the vehicle according to a fully automatic or fully autonomous driving mode according to level 5 of the SAE J3016 classification. Guiding the vehicle at least in part automatically may also comprise guiding the vehicle according to a partly automatic or partly autonomous driving mode according to levels 1 to 4 of the SAE J3016 classification.

According to a further aspect of the invention, a computer program comprising instructions, which, when executed by a data processing device, cause the data processing device to carry out a computer-implemented method for computing height information of a curb according to the invention, is provided.

According to a further aspect of the invention, a further computer program comprising further instructions, which, when executed by an electronic vehicle guidance system according to the invention, in particular the data processing device of the electronic vehicle guidance system, cause the electronic vehicle guidance system to carry out a method for semi-automated or fully automated parking of a vehicle according to the invention, is provided.

The instructions and/or further instruction may be provided as program code. The program code can be provided as binary code or assembler and/or as source code of a programming language, for example C, and/or as program script, for example Python.

According to a further aspect of the invention, a computer readable storage medium storing a computer program and/or a further computer program according to the invention, is provided.

Further features of the invention are apparent from the claims, the figures and the figure description. The features and combinations of features mentioned above in the description as well as the features and combinations of features mentioned below in the description of figures and/or shown in the figures may be comprised by the invention not only in the respective combination stated, but also in other combinations. In particular, embodiments and combinations of features, which do not have all the features of an originally formulated claim, may also be comprised by the invention. Moreover, embodiments and combinations of features which go beyond or deviate from the combinations of features set forth in the recitations of the claims may be comprised by the invention.

In the following, the invention will be explained in detail with reference to specific exemplary implementations and respective schematic drawings. In the drawings, identical or functionally identical elements may be denoted by the same reference signs. The description of identical or functionally identical elements is not necessarily repeated with respect to different figures.

In the figures,

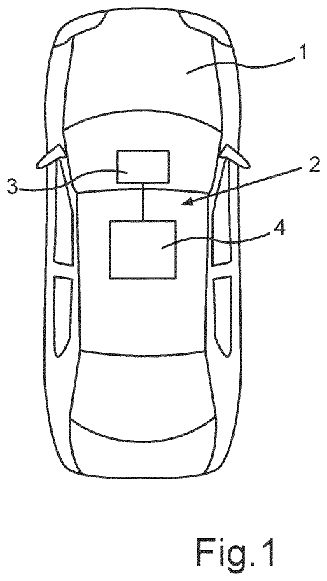

FIG. 1 shows a schematic representation of a vehicle with an exemplary implementation of an electronic vehicle guidance system according to the invention;

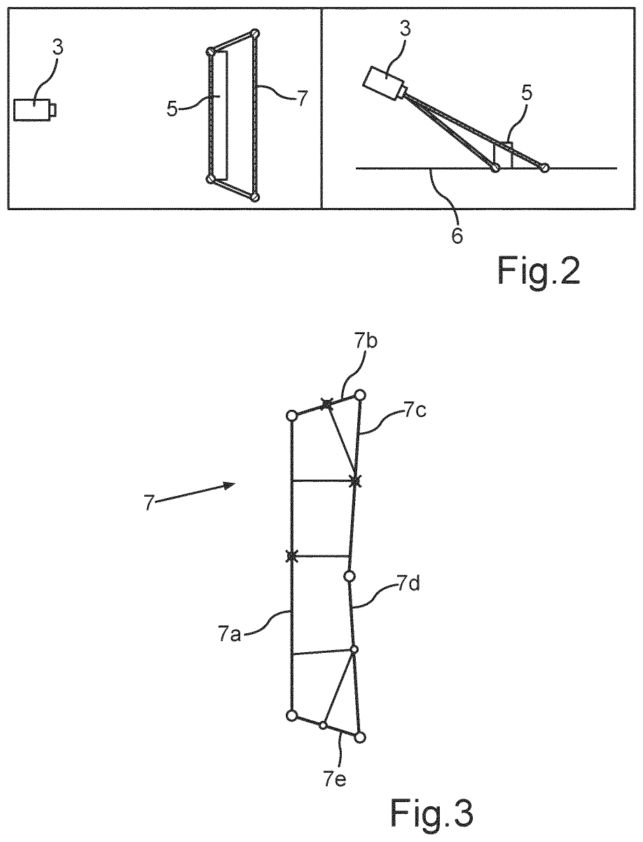

FIG. 2 shows a schematic illustration of method steps of an exemplary implementation of a computer-implemented method for computing height information of a curb according to the invention;

FIG. 3 shows a schematic illustration of further method steps of an exemplary implementation of a computer-implemented method for computing height information of a curb according to the invention;

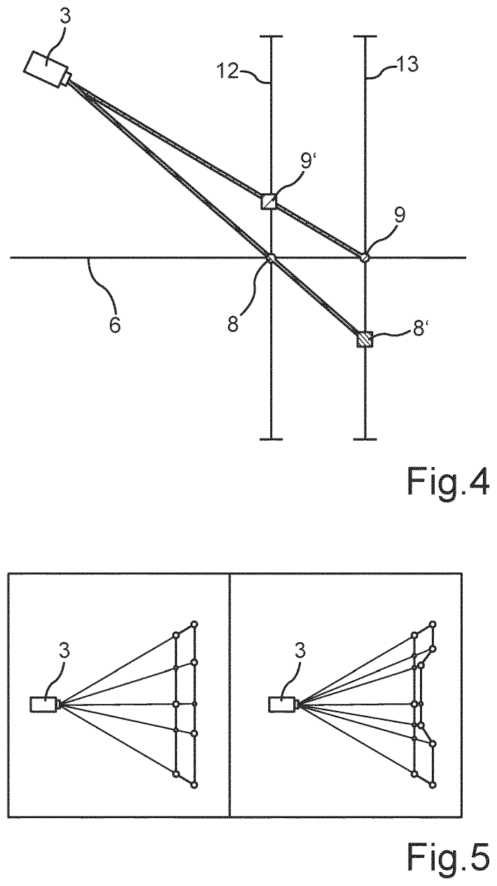

FIG. 4 shows a schematic illustration of further method steps of an exemplary implementation of a computer-implemented method for computing height information of a curb according to the invention;

FIG. 5 shows a schematic illustration of further method steps of an exemplary implementation of a computer-implemented method for computing height information of a curb according to the invention;

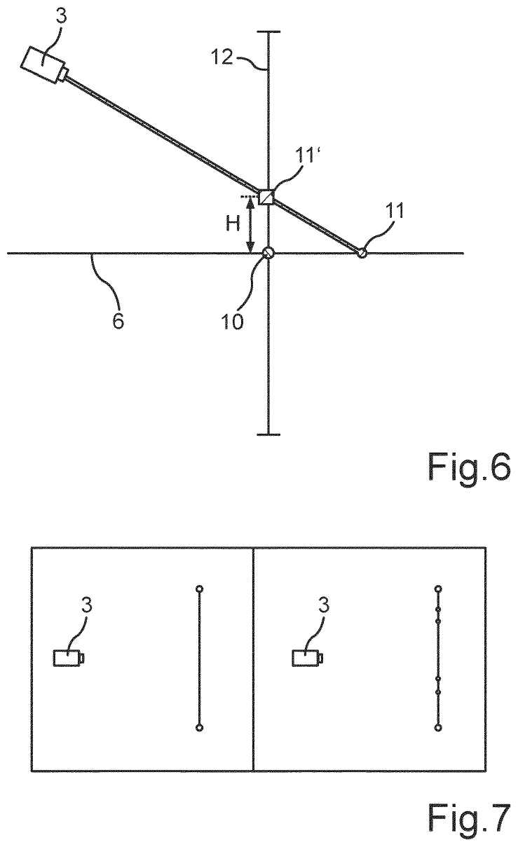

FIG. 6 shows a schematic illustration of further method steps of an exemplary implementation of a computer-implemented method for computing height information of a curb according to the invention; and

FIG. 7 shows a schematic illustration of further method steps of an exemplary implementation of a computer-implemented method for computing height information of a curb according to the invention;

FIG. 1 shows a vehicle 1 with an exemplary implementation of an electronic vehicle guidance system 2 for semi-automated or fully automated parking of the vehicle 1 to a parking space, which is at least in part confined by a curb 5 (see FIG. 2). The electronic vehicle guidance system 2 is configured to carry out a method for semi-automated or fully automated parking of the vehicle 1 according to the invention. The electronic vehicle guidance system 2 comprises a camera 3 for the vehicle 1, in particular a front camera or side camera or rear camera of the vehicle 1. The camera 3 is configured to generate an image depicting the curb 5. The electronic vehicle guidance system 2 further comprises a data processing device containing a computing unit 4, which may be understood to represent one or more computing units. The computing unit 4 is configured to carry out a computer-implemented method for computing height information of the curb 5 according to the invention.

The computing unit 4 is configured to generate driver assistance information for guiding the vehicle 1 towards the parking space for a driver of the vehicle 1 depending on the height information and/or to generate at least one control signal for affecting a longitudinal and/or lateral control of the vehicle 1 to guide the vehicle 1 at least in part automatically towards the parking space depending on the height information.

To carry out the computer-implemented method for computing height information of the curb 5, the computing unit 4 determines a set of straight line segments 7 as illustrated in FIG. 2, which approximates a projection of an outline of the curb 5 to the ground plane 6 (see FIG. 4), depending on the image. For example, image level curb contours may be examined using a corner detection algorithm and detected corners are projected to the ground plane 6. Adjacent corners are joined to create the initial line segments. Adjacent line segments that have similar orientations may be merged.

After the line segments are created, they are classified based on whether they belong to the upper and the lower edge of the curb 5, respectively. For classifying a first segment, it is paired with a second segment on the opposite edge of the curb 5. This is illustrated in FIG. 3. In particular, for a first segment of the set of straight line segments 7, for example for segment 7a in FIG. 3, a perpendicular bisector is computed and a second segment of the set of straight line segments 7 is determined, which intersects the perpendicular bisector of the first segment at an intersection point, for example segment 7c in the illustration of FIG. 3. Analogously, segment 7d as a first segment can be paired with segment 7a as a second segment.

In some implementations, the pairing may be subject to further conditions. For example, two segments may be paired only if their distance is below a predefined threshold and/or they may be paired only, if the angle they include is smaller than a certain further threshold. In the example of FIG. 3, segments 7b and 7e might not be paired with another segment due to said conditions.

As illustrated in FIG. 4, a first plane 12, which is perpendicular to the ground plane 6 and comprises the first segment, is determined and a second plane 13, which is perpendicular to the ground plane 6 and comprises the second segment, is determined. A midpoint 8 of the first segment is projected to the second plane 13, and the intersection point 9 of the second segment with the perpendicular bisector of the first segment is projected to the first plane 12 by means of respective perspective projections using a predefined position of the camera 3 as a vanishing point. Depending on respective heights above the ground plane 6 of the projected midpoint 8′ and the projected intersection point 9′, one of the first and the second segment is classified as an upper segment and the other one of the first and the second segment is classified as a lower segment. In particular, if the height of the projected midpoint 8′ is greater, the upper segment is given by the first segment and the lower segment is given by the second segment. Otherwise, as is the case in the example of FIG. 3, the upper segment is given by the second segment and the lower segment is given by the first segment.

Then, as illustrated in FIG. 6, a pair of points 10, 11 is determined, wherein the lower segment comprises a lower point 10 of the pair of points 10, 11 and the upper segment comprises an upper point 11 of the pair of points 10, 11.

As illustrated in FIG. 5, in order to define the pair of points 10, 11, a projected position of the camera 3 may be determined by projecting the position of the camera 3 to the ground plane 6. The lower point 10 corresponds to an end point of the lower segment and the upper point 11 corresponds to a point of intersection of the upper segment with a straight line passing through the projected position of the camera 3 and the lower point 10. This is for example the case in FIG. 6. Alternatively, the upper point 11 corresponds to an end point of the upper segment and the lower point 10 corresponds to a point of intersection of the lower segment with a straight line passing through the projected position of the camera 3 and the upper point 11.

Referring again to FIG. 6, the upper point 11 is projected to a further plane, which is perpendicular to the ground plane 6 and comprises the lower segment, by means of a perspective projection using the position of the camera 3 as a vanishing point. In the example of FIG. 6, the further plane is identical to the first plane 12. A height H of the projected upper point 11′ above the ground plane 6 is determined. Height information comprising a position of the lower point 10 in the ground plane 6 and the height H of the projected upper point 11′ associated to the lower point 10 is stored.

Consequently, a three-dimensional representation of the curb 5, can be provided as illustrated in FIG. 8 for two examples. Therein, each circle corresponds to a point on the respective lower segment, and a respective height H is associated to it.

1. A computer-implemented method for computing height information of a curb in an environment of a vehicle, the computer-implemented method comprises:
receiving an image, which depicts the curb, from a camera of the vehicle and a set of straight line segments, which approximates a projection of an outline of the curb to a predefined ground plane, is determined depending on the image;
computing, for a first segment of the set of straight line segments, a perpendicular bisector and a second segment of the set of straight line segments is determined, which intersects the perpendicular bisector of the first segment at an intersection point;
determining a first plane, which is perpendicular to the ground plane and comprises the first segment and a second plane, which is perpendicular to the ground plane and comprises the second segment, is determined;
projecting a midpoint of the first segment to the second plane and the intersection point of the second segment is projected to the first plane by means of respective perspective projections using a predefined position of the camera as a vanishing point;
classifying, depending on respective heights above the ground plane of the projected midpoint and the projected intersection point, one of the first and the second segment as an upper segment and the other one of the first and the second segment as a lower segment;
determining a pair of points, wherein the lower segment comprises a lower point of the pair of points and the upper segment comprises an upper point of the pair of points;
determining the upper point is projected to a further plane, which is perpendicular to the ground plane and comprises the lower segment, by means of a perspective projection using the position of the camera as a vanishing point, and a height of the projected upper point above the ground plane; and
storing height information comprising a position of the lower point in the ground plane and the height of the projected upper point associated to the lower point.

2. The computer-implemented method according to claim 1,
giving the upper segment is given by the first segment and the lower segment by the second segment, if a height of the projected midpoint above the ground plane is greater than a height of the projected intersection point above the ground plane; and
giving the upper segment by the second segment and the lower segment is given by the first segment, if the height of the projected midpoint above the ground plane is smaller than the height of the projected intersection point above the ground plane.

3. The computer-implemented method according to claim 1, further comprising determining a projected position of the camera by projecting the position of the camera to the ground plane,
wherein the lower point corresponds to an end point of the lower segment and the upper point corresponds to a point of intersection of the upper segment with a straight line passing through the projected position of the camera and the lower point; or
wherein the upper point corresponds to an end point of the upper segment and the lower point corresponds to a point of intersection of the lower segment with a straight line passing through the projected position of the camera and the upper point.

4. The computer-implemented method according to claim 1, further comprising:
determining a further pair of points, wherein the lower segment comprises a further lower point of the further pair of points and the upper segment comprises a further upper point of the further pair of points; and
projecting the further upper point to the plane, which is perpendicular to the ground plane and comprises the lower segment, by means of a perspective projection using the position of the camera as a vanishing point, and a height of the projected further upper point above the ground plane is determined,
wherein the height information comprises a position of the further lower point in the ground plane and the height of the projected further upper point associated to the further lower point.

5. The computer-implemented method according to claim 1, further comprising:
generating a semantically segmented image by applying a semantic segmentation algorithm to the image; and
determining the set of straight line segments depending on the semantically segmented image.

6. The computer-implemented method according to claim 5, further comprising:
determining a plurality of corner points of the curb by applying a corner detection algorithm to the semantically segmented image;
projecting the plurality of corner points to the ground plane; and
determining the set of straight line segments depending on the projected plurality of corner points.

7. A method for semi-automated or fully automated parking of a vehicle to a parking space, which is at least in part confined by a curb, wherein the computer-implemented method according to claim 1 is carried out by at least one computing unit of the vehicle,
wherein driver assistance information for guiding the vehicle towards the parking space is output to a driver of the vehicle depending on the height information; and/or
wherein the vehicle is guided at least in part automatically towards the parking space by generating at least one control signal for affecting a longitudinal and/or lateral control of the vehicle depending on the height information.

8. A data processing device comprising at least one computing unit, which is adapted to carry out the computer-implemented method according to claim 1.

9. An electronic vehicle guidance system for semi-automated or fully automated parking of a vehicle to a parking space, which is at least in part confined by a curb, wherein the electronic vehicle guidance system comprises a camera, which is configured to generate an image depicting the curb, and a data processing device according to claim 8, wherein the at least one computing unit is configured to generate:
driver assistance information for guiding the vehicle towards the parking space for a driver of the vehicle depending on the height information; and/or
at least one control signal for affecting a longitudinal and/or lateral control of the vehicle to guide the vehicle at least in part automatically towards the parking space depending on the height information.

10. A non-transitory computer readable storage medium comprising a computer program comprising instructions, which, when executed by a data processing device, cause the data processing device to carry out a computer-implemented method according to claim 1.

11. (canceled)

12. (canceled)
